(19) United States
(12) Patent Application Publication
(10) Pub. No.: US 2019/0011222 A1
(43) Pub. Date: Jan. 10, 2019

(54) FIREARM STORAGE SYSTEMS AND RELATED APPARATUS AND METHODS

(71) Applicant: Rhino Metals, Inc., Caldwell, ID (US)

(72) Inventor: Donald K. Suggs, Boise, ID (US)

(21) Appl. No.: 15/644,654

(22) Filed: Jul. 7, 2017

(51) Int. Cl. F41C 33/06; A47B 81/00; E05G 1/024

(52) U.S. Cl. CPC F41C 33/06; E05G 1/024; A47B 81/005

(57) ABSTRACT

Firearm storage systems and related methods and apparatus. In some embodiments, the system may comprise a firearm storage structure configured to store one or more firearms therein; a panel coupled to an interior surface of the firearm storage structure; and one or more rods. The rod(s) may be configured to be received in a barrel of a firearm. The rod(s) may further comprise a tip configured to penetrate the panel. The panel may be made up of a material that is configured to removably receive the tips of the rods with each of the rods extending into a barrel of one of the firearms so as to allow the firearm(s) to be stored in an upright position within the firearm storage structure.

### SUMMARY

Systems and methods are disclosed herein relating to improving storage of rifles and other firearms in various storage structures, such as, for example safes and/or gun cabinets. In some embodiments, the inventive concepts disclosed herein may allow for improving the efficiency of storage space within such structures by allowing firearms to be stored in an upright position within the storage structure without requiring that they be leaned against an interior wall of the structure or another item within the structure.

In a more particular example of a system for storage of firearms, the system may comprise a firearm storage structure configured to store a plurality of firearms therein, such as a gun safe or gun cabinet; a panel coupled to an interior surface of the firearm storage structure; and a plurality of rods. Each of the plurality of rods may be configured to be received in a barrel of one of the plurality of firearms. Each of the plurality of rods may comprise a tip configured to penetrate the panel. Preferably, the panel is made up of a material that is configured to removably receive the tips of the rods with each of the rods extending into a barrel of one of the plurality of firearms so as to allow each of the plurality of firearms to be stored in an upright position within the firearm storage structure, such as a foam or a foam-like material.

In some embodiments, the interior surface may comprise at least one of a lower surface of a shelf positioned within the safe and an overhead interior surface of the safe.

In some embodiments, each of the plurality of rods may comprise means for preventing the rod from falling completely into a barrel of a firearm, such as a washer or pin. In some such embodiments, the means for preventing the rod from falling completely into a barrel of a firearm may be positioned in between the tip and an end of the rod opposite from the tip. In some embodiments, the washer or other means for preventing the rod from falling completely into a barrel of a firearm may be movably positioned on the rod.

In some embodiments, the tip of each of the plurality of rods may comprise a threaded tip configured to be threadably received within the panel.

In another specific example of a system for storage of firearms according to other embodiments, the system may comprise a panel configured to be coupled to at least one of a lower surface of a shelf and an overhead interior surface of a firearm storage structure; and one or more rods comprising a penetrating tip at a first end of the rod and a barrel-receiving portion at a second end of the rod opposite from the first end. The barrel-receiving portion of the rod may be configured to be received within a barrel of a firearm, and the penetrating tip may be configured to be received within the panel so as to support the firearm in an upright position within the firearm storage structure. In some embodiments, the penetrating tip may be configured to be removably received within the panel such that the penetrating tip can be received within the panel, removed from the panel, and received within the panel again after being removed from the panel.

In some embodiments, the panel may comprise a resiliently-penetrable panel configured to allow the penetrating tip to be repeatedly inserted and removed from the resiliently-penetrable panel. In some such embodiments, the resiliently-penetrable panel may be configured to allow the penetrating tip to be repeatedly inserted and removed from the resiliently-penetrable panel at a single location. In some embodiments, the penetrating tip may be threaded.

Some embodiments may further comprise a barrel seat configured to engage an end of the barrel, which may be positioned in between the penetrating tip and the barrel-receiving portion, such as a washer. In some such embodiments, the washer may be movably positioned on the rod.

In a specific example of a method for storing firearms within a storage structure, the method may comprise coupling a penetrable panel with an interior surface of a storage structure; inserting a rod into a barrel of a firearm, and inserting the penetrating tip into the penetrable panel. The rod may comprise a penetrating tip, and the rod and/or the penetrable panel may keep the firearm aligned within the storage structure along, or at least substantially along, an axis defined by the rod.

In some implementations, the penetrable panel may comprise a resiliently-penetrable panel. In some such implementations, the method may further comprise, after the step of inserting the penetrating tip into the resiliently-penetrable panel, removing the penetrating tip from the resiliently-penetrable panel and inserting the penetrating tip into the resiliently penetrable panel a second time. In some implementations, the step of inserting the penetrating tip into the resiliently-penetrable panel a second time may comprise inserting the penetrating tip into the resiliently-penetrable panel at a location distinct from a location at which the penetrating tip was previously inserted into the resiliently-penetrable panel.

Some implementations may further comprise removing the penetrable panel from the interior surface of the storage structure and coupling a new penetrable panel with the interior surface of the storage structure.

The features, structures, steps, or characteristics disclosed herein in connection with one embodiment may be combined in any suitable manner in one or more alternative embodiments.

### BRIEF DESCRIPTION OF THE DRAWINGS

Non-limiting and non-exhaustive embodiments of the disclosure are described, including various embodiments of the disclosure with reference to the figures, in which:

FIG. 1 is a perspective view of a firearm storage system according to some embodiments;

FIG. 2 is a partial, front elevation view of another firearm storage system;

FIG. 3 is a lower plan view of a panel of the firearm storage system of FIG. 2;

FIG. 4 is a partial, front elevation view of a firearm storage system according to another embodiment;

FIG. 5 is a perspective view of a shelf and accompanying panel of the firearm storage system of FIG. 4;

FIG. 6 depicts the tip of a rod of the firearm storage system of FIG. 4;

FIG. 7 depicts a barrel seat of the firearm storage system of FIG. 4; and

FIG. 8 is a partial, perspective view of a firearm storage system according to yet another embodiment.

### DETAILED DESCRIPTION

A detailed description of apparatus, systems, and methods consistent with various embodiments of the present disclosure is provided below. While several embodiments are described, it should be understood that the disclosure is not limited to any of the specific embodiments disclosed, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

Apparatus, methods, and systems are disclosed herein relating to improving the efficiency of storage space within a firearm storage structure, such as a gun safe or gun cabinet, for example. More particularly, in some embodiments, the system may comprise a panel configured to be coupled to an interior surface of a firearm storage structure and one or more rods. The rod(s) may be configured to be received in a barrel of a firearm. The rod(s) may further comprise a tip configured to penetrate the panel. The panel may be made up of a material that is configured to removably receive the tips of the rods with each of the rods extending into a barrel of one of the firearms so as to allow the firearm(s) to be stored in an upright position within the firearm storage structure.

The embodiments of the disclosure may be best understood by reference to the drawings, wherein like parts may be designated by like numerals. It will be readily understood that the components of the disclosed embodiments, as generally described and illustrated in the figures herein, could be arranged and designed in a wide variety of different configurations. Thus, the following detailed description of the embodiments of the apparatus and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified. Additional details regarding certain preferred embodiments and implementations will now be described in greater detail with reference to the accompanying drawings.

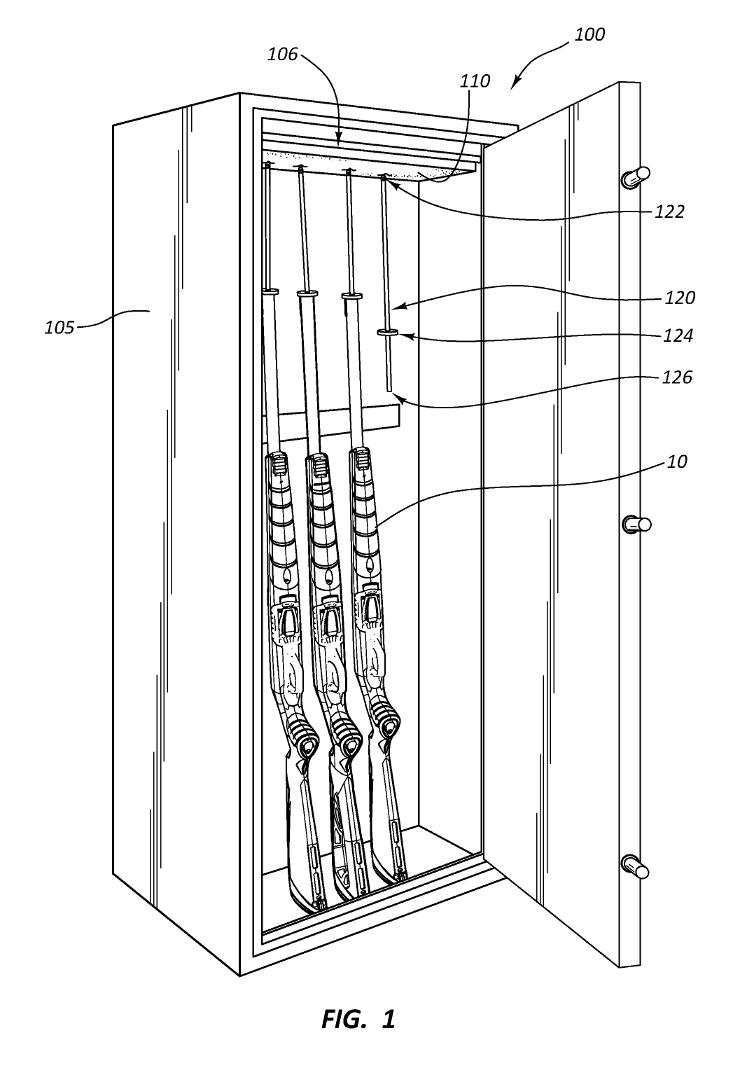

FIG. 1 depicts a system 100 for storage of firearms according to some embodiments. As shown in this figure, system 100 comprises a firearm storage structure 105 configured to store a plurality of firearms 10 therein. More particularly, in the depicted embodiment, system 100 comprises a safe 105 configured to store rifles 10 therein. However, it is contemplated that, in alternative embodiments, other firearms storage structures may be used, such as gun cabinets and the like.

System 100 further comprises a panel 110, which is coupled to an interior surface 106 of safe 105. In the depicted embodiment, interior surface 106 comprises an overhead interior surface or ceiling of safe 105. However, as discussed below in connection with other embodiments, panel 110 may instead be coupled with another interior surface of safe 105, such as a lower surface of a shelf positioned within safe 105 or another firearm storage structure, for example.

Panel 110 preferably comprises a penetrable material, such as a foam or foam-like material. Even more preferably, panel 110 comprises a material configured to be removably received and/or repeatedly penetrated by rods 120. Thus, preferably panel 110 comprises a resiliently-penetrable panel. Specific examples of suitable materials for panel 110 include various foams, such as closed-cell and open-cell foams, including, for example, polyethylene foam, polyurethane foam, polystyrene foam, an ethylene-vinyl acetate foam, layered mesh material, a thermoplastic material, and the like.

Panel 110 may be coupled with interior surface 106 in a number of different ways. For example, panel 110 may be coupled with interior surface 106 using an adhesive, fasteners, tape, or the like, or may be coupled with a support structure, such as clips, brackets, braces, posts, or the like, used to support a shelf on which interior surface 106 may be positioned. In some embodiments, as discussed in greater detail below, panel 110 may be removably coupled with interior surface 106, such as by way of hook-and-loop fabric, for example.

System 100 further comprises a plurality of rods 120 that may be used to maintain rifles 10 or other firearms in a desired position, such as, in the depicted embodiment, an upright position. This may allow for greater utilization of interior storage space within safe 105 to allow for storage of more rifles and/or use of the additional space for storage of other items, such as gun accessories, for example.

However, alternative embodiments are contemplated in which rods may be used to maintain rifles or other firearms in non-upright and/or non-vertical orientations. For example, in some embodiments, rods may extend horizontally or diagonally from a panel and may be used to store firearms in a variety of desired configurations as desired in order to optimize the internal storage area of a firearm storage structure. Most notably, handguns, for example, might be stored horizontally using panels coupled to an inner side wall of such a structure.

Rods 120 may also comprise a barrel seat 124, which may be configured to engage the end of a barrel of a rifle 10 or other firearm in order to prevent the entire rod 120 from falling into the barrel. In some embodiments and implementations, use of a barrel seat 124, and in particular a movable barrel seat 124, may allow for very limited penetration or, in some cases, no penetration, of the panel 110. In other words, by inserting a rod into a barrel and moving the barrel seat 124 to firmly abut the end of the barrel as the tip of the rod is abutted against the panel 110 (or against another surface), the rod may be capable of supporting the rifle 10 without panel penetration, or with very little panel penetration.

In the embodiment depicted in FIG. 1, barrel seat 124 comprises a washer. Washer 124 may be rigidly affixed to a portion of rod 120 or, alternatively, may be slidably received on rod 120 to allow for repositioning of washer 124 on rod 120. Barrel seat 124 may be made up of any suitable material, such as an ethylene-vinyl acetate foam, a plastic, rubber, a metal, wood, and the like. Barrel seat 124 is an example of means for preventing a rod from falling completely into a barrel of a firearm.

In practice, typically a barrel-receiving portion 126 of the rod 120 is inserted into the barrel of a rifle 10 or another firearm, after which the rod may be raised up and tip 122 of rod 120 inserted into the panel 110 so as to penetrate the panel 110. Preferably, the material making up panel 110 is sufficiently strong to hold tip 122 in place and provide sufficient strength to prevent an associated rifle 10 from tipping over or otherwise being removed from the desired alignment created by rod 120. Similarly, preferably rod 120 comprises a sufficiently rigid material also with sufficient strength to maintain its associated rifle 10 or other firearm in a desired orientation/position. Examples of suitable materials for rod 120 include various rigid materials, such as metals, rigid plastics, fiberglass, wood, and the like.

In preferred embodiments, tip 122 may be configured to facilitate penetration into panel 110. For example, tip 122 may be pointed and/or threaded to facilitate a secure coupling with panel 110.

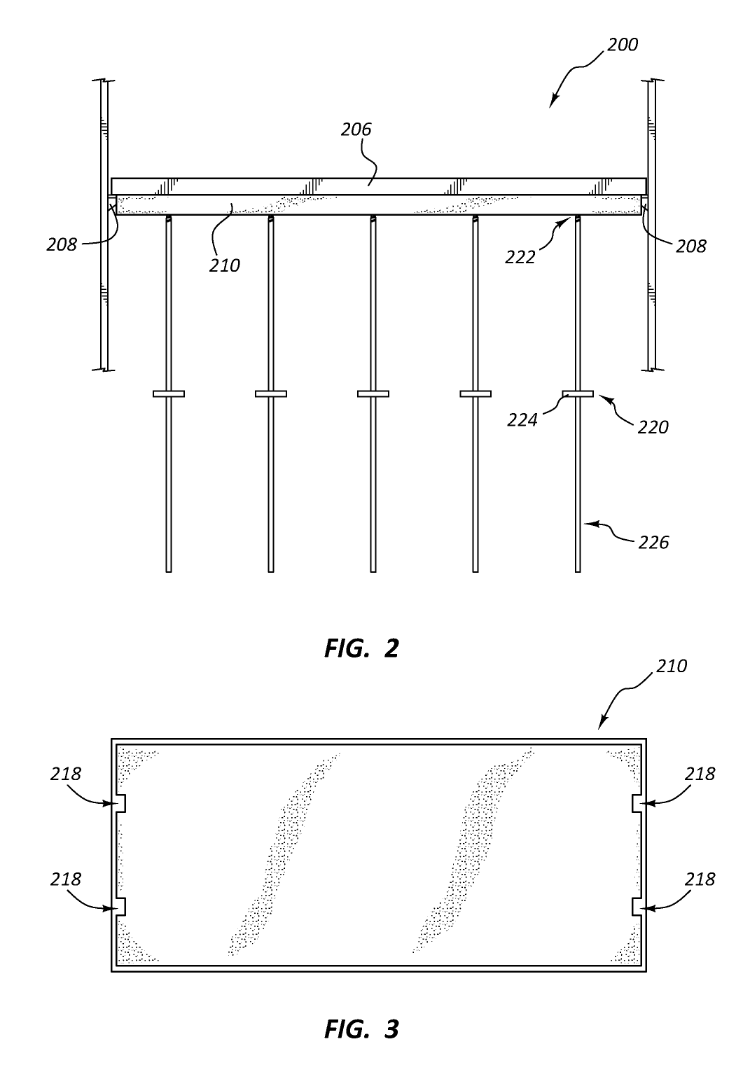

FIG. 2 illustrates a system 200 for storage of firearms according to other embodiments. As shown in this figure, system 200 comprises a panel 210, which is coupled to an interior surface of a shelf 206 of a firearm storage structure, such as a gun safe or cabinet. Because panel 210 is coupled with a shelf 206 rather than a ceiling of a firearm storage structure, it may be coupled with shelf 206 by coupling with a peg, clip, bracket, or the like, that is used to support shelf 206, such as posts 208 depicted in FIG. 2. Thus, if desired, panel 210 may be removably coupled with shelf 206. However, in alternative embodiments, panel 210 may also, or alternatively, be rigidly coupled with shelf 206, such as by way of an adhesive, tape, fasteners, or the like.

As with system 100, system 200 may comprise a plurality of rods 220 comprising tips 222, barrel seats 224, and barrel-receiving portions 226. As previously described, tips 222 of rods 220 may be penetrated within panel 210 and opposing barrel-receiving portions 226 received within respective barrels of firearms (not shown) to facilitate an efficient storage system for the firearms.

As shown in FIG. 3, panel 210 may further comprise a plurality of slots 218 configured to receive posts 208 or other structures for supporting a shelf 206. In this manner, panel 210 may be removably coupled with shelf 206 or another internal surface of a firearm storage structure. Thus, once panel 210 has been worn out, such as after being repeatedly penetrated by rods 220 a certain number of times to make the coupling between tips 222 and panel 210 more difficult to maintain, a new panel 210 can be installed. It should be understood that slots 218 may be formed to extend all of the way through panel 210 to allow for posts 208 to contact shelf 206 or, alternatively, slots 218 may only partially extend through panel 210 such that posts 208 instead contact panel 210.

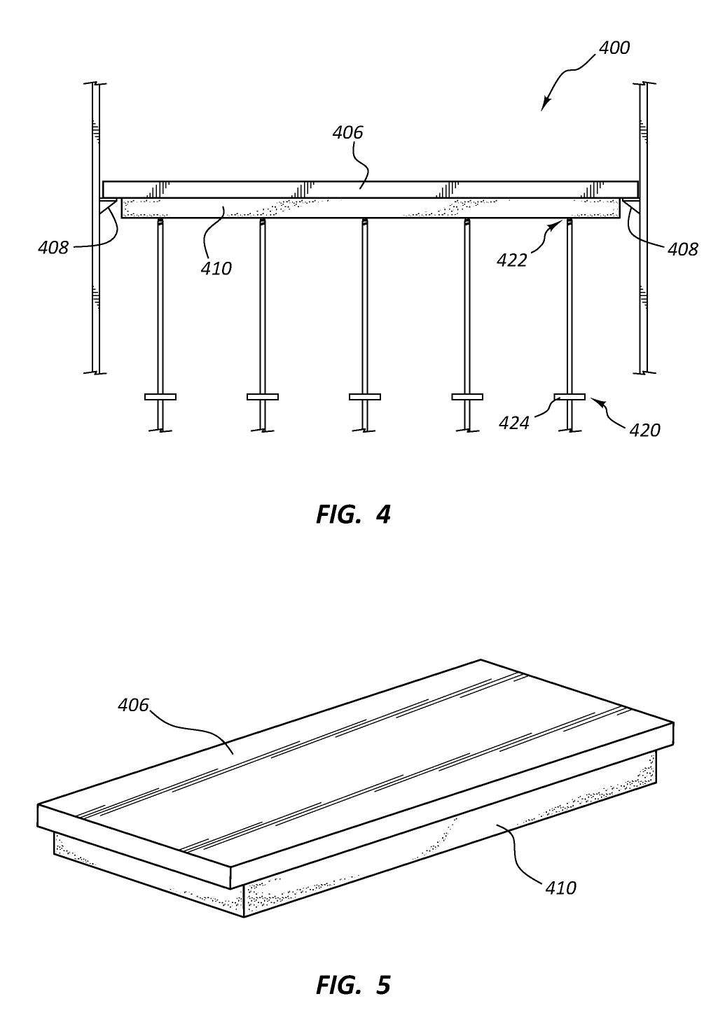

FIG. 4 illustrates another system 400 for storage of firearms according to other embodiments. As shown in this figure, system 400 again comprises a panel 410, which is coupled to a lower surface of a shelf 406 of a firearm storage structure, such as a gun safe or cabinet. Unlike panel 210, which is coupled with posts 208, panel 410 is undersized relative to shelf 406, as also depicted in FIG. 5, and is therefore configured to avoid direct contact with posts 408 or another structure used to support shelf 406. Thus, panel 410 may be non-removably and/or rigidly coupled with the lower surface of shelf 406, such as by way of an adhesive, tape, fasteners, or the like. Of course, panel 410 may instead still be removably coupled with shelf 406 if desired to facilitate removal and reattachment of a new panel 410, as previously described. This may be done, for example, by way of hook-and-loop fabric, detachable fasteners, etc. In some embodiments, if a suitable foam material is used to form panel 410, a series of nails or other fasteners may be used to couple panel 410 with shelf 406. If suitable fasteners are used, such as nails, the panel 410 may be removable from the shelf 406 by simply pulling it off of the fasteners.

As with systems 100 and 200, system 400 further comprises one or more rods 420 comprising tips 422, barrel seats 424, and barrel-receiving portions. As previously described, tips 422 of rods 420 may be penetrated within panel 410 and opposing barrel-receiving portions received within respective barrels of firearms (not shown) to facilitate an efficient storage system for the firearms.

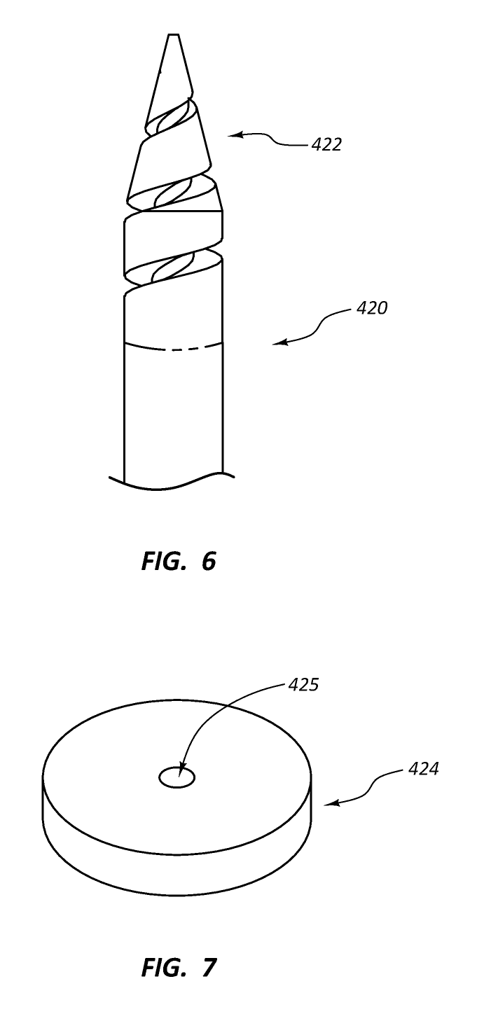

FIG. 6 depicts a close-up view of a tip 422 of a rod 420 according to a preferred embodiment. As shown in this figure, tip 422 may be threaded and pointed to facilitate a secure coupling with a panel 410 without unduly altering the panel 410. Threaded tips may also be useful to facilitate removal of the tip 422 to provide for repeated penetration into a panel 410 to improve its useful life.

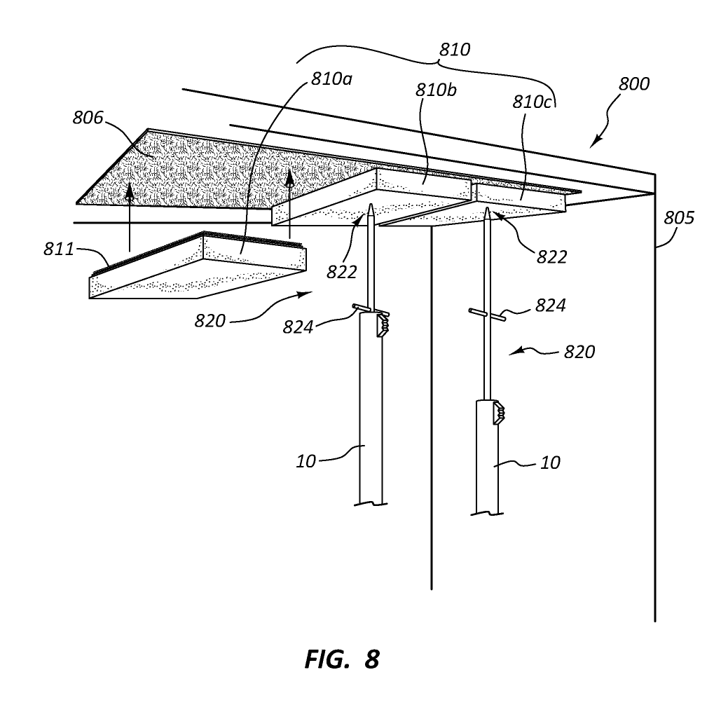

FIG. 7 depicts a barrel seat 424 comprising a washer according to preferred embodiments. As shown in this figure, washer 424 comprises a hole 425 through which a rod 420 is configured to extend. In some embodiments, one or more rods 420 may comprise a circumferential groove, or multiple circumferential grooves, such that hole 425 of washer 424 is configured to engage rod 420 at such groove(s). In some embodiments, washer 424 may be movably coupled with rod 420 such that, upon inserting rod 420 into a rifle or other firearm and penetrating tip 422 into a panel 410, washer 424 may be slid down to engage the end of the barrel of the rifle/firearm.

However, in alternative embodiments, washer 424 may be permanently fixed to rod 420 at a predetermined location, such as near tip 422. Thus, washer 424 need not engage the end of the barrel of the rifle/firearm while in use in all embodiments. Indeed, washer 424 may be positioned between the end of the barrel of the rifle/firearm and the tip 422 during use such that, upon removing tip 422 from panel 410, in the event that a user releases rod 420, washer 424 will then engage the end of the barrel of the rifle/firearm to prevent the rod 420 from fully entering the barrel.

FIG. 8 illustrates yet another example of a system 800 for storage of firearms. System 800 differs from those depicted in previous figures in several respects. For example, as shown in this figure, system 800 comprises a panel 810 that comprises a series of sub-panels, namely, sub-panels 810a, 810b, and 810c. Each of sub-panels 810a, 810b, and 810c is removably coupleable with an interior surface of a firearm storage structure 805, such as a gun safe or gun cabinet. In the depicted embodiment, this is accomplished by coupling a first sheet 806, which may comprise a hook-and-loop fabric material, to the interior surface, such as by way of an adhesive, for example. The interior surface comprises an overhead lower surface of structure 805 in the depicted embodiment, such as the ceiling of structure 805. However, sheet 806 may be applied to other interior surfaces if desired, as previously mentioned. In addition, alternative embodiments are contemplated in which a plurality of sheets 806 may be provided, the number of sheets of which may be the same as the number of sub-panels.

Each of the sub-panels, such as sub-panels 810a, 810b, and 810c, may similarly comprise a sheet 811 configured to facilitate attachment to sheet(s) 806. In this manner, if one or more particular regions of panel 810 experiences heavier use than other regions, this region or regions may be replaced without replacing the entire panel 810 by removing the sub-panel(s) associated with this region or regions and applying a new sub-panel or sub-panels.

Rods 820 of system 800 also differ from those previously described (although any of the previously-described rods may be used with system 800 as desired). Although rods 820 again comprise tips 822 and barrel seats 824, these elements differ from those of the previously-depicted embodiments. More particularly, tips 822 are pointed but not threaded. And, with respect to barrel seats 824, instead of washers, barrel seats 824 comprise pins that extend through rods 820 to provide a structure for engaging and preventing rods 820 from being fully received within a barrel of a firearm 10. Each of the barrel seats disclosed herein, including barrel seats 124, 224, 424, and 824, are examples of means for preventing a rod from falling completely into a barrel of a firearm.

The foregoing specification has been described with reference to various embodiments and implementations. However, one of ordinary skill in the art will appreciate that various modifications and changes can be made without departing from the scope of the present disclosure. For example, various operational steps, as well as components for carrying out operational steps, may be implemented in various ways depending upon the particular application or in consideration of any number of cost functions associated with the operation of the system. Accordingly, any one or more of the steps may be deleted, modified, or combined with other steps. Further, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced, are not to be construed as a critical, a required, or an essential feature or element.

Those having skill in the art will appreciate that many changes may be made to the details of the above-described embodiments without departing from the underlying principles of the invention. The scope of the present inventions should, therefore, be determined only by the following claims.

1. A system for storage of firearms, comprising:
a firearm storage structure configured to store a plurality of firearms therein;
a panel coupled to an interior surface of the firearm storage structure; and
a plurality of rods,
wherein each of the plurality of rods is configured to be received in a barrel of one of the plurality of firearms,
wherein each of the plurality of rods comprises a narrowed tip configured to penetrate the panel, and
wherein the panel is made up of a material that is configured to removably receive the narrowed tips of the rods with each of the rods extending into a barrel of one of the plurality of firearms to allow each of the plurality of firearms to be stored in an upright position within the firearm storage structure.

2. The system of claim 1, wherein the firearm storage structure comprises a safe.

3. The system of claim 2, wherein the interior surface comprises at least one of a lower surface of a shelf positioned within the safe and an overhead interior surface of the safe.

4. The system of claim 1, wherein the material comprises at least one of a foam and a foam-like material.

5. The system of claim 1, wherein each of the plurality of rods comprises means for preventing the rod from falling completely into a barrel of a firearm, and wherein the means for preventing the rod from falling completely into a barrel of a firearm is positioned in between the narrowed tip and an end of the rod opposite from the narrowed tip.

6. The system of claim 5, wherein the means for preventing the rod from falling completely into a barrel of a firearm comprises a washer.

7. The system of claim 6, wherein the washer is movably positioned on the rod.

8. The system of claim 1, wherein the narrowed tip of each of the plurality of rods comprises a threaded tip configured to be threadably received within the panel.

9. A system for storage of firearms, comprising:
a panel configured to be coupled to at least one of a lower surface of a shelf and an overhead interior surface of a firearm storage structure;
a rod comprising a pointed, penetrating tip at a first end of the rod and a barrel-receiving portion at a second end of the rod opposite from the first end,
wherein the barrel-receiving portion of the rod is configured to be received within a barrel of a firearm,
wherein the pointed, penetrating tip is configured to be received within the panel so as to support the firearm in an upright position within the firearm storage structure, and
wherein the pointed, penetrating tip is configured to be removably received within the panel such that the pointed, penetrating tip can be received within the panel, removed from the panel, and received within the panel again after being removed from the panel.

10. The system of claim 9, wherein the panel comprises a resiliently-penetrable panel configured to allow the pointed, penetrating tip to be repeatedly inserted and removed from the resiliently-penetrable panel.

11. The system of claim 10, wherein the resiliently-penetrable panel is configured to allow the pointed, penetrating tip to be repeatedly inserted and removed from the resiliently-penetrable panel at a single location.

12. The system of claim 9, wherein the pointed, penetrating tip is threaded.

13. The system of claim 9, wherein the rod further comprises a barrel seat configured to engage an end of the barrel.

14. The system of claim 13, wherein the barrel seat is positioned in between the pointed, penetrating tip and the barrel-receiving portion.

15. The system of claim 13, wherein the barrel seat comprises a washer.

16. The system of claim 15, wherein the washer is movably positioned on the rod.

17. A method for storing firearms within a storage structure, the method comprising the steps of:
coupling a penetrable panel with an interior surface of a storage structure;
inserting a rod into a barrel of a firearm, wherein the rod comprises a narrowed, penetrating tip; and
inserting the narrowed, penetrating tip into the penetrable panel, wherein the rod and the penetrable panel keep the firearm aligned within the storage structure along an axis at least substantially defined by the rod.

18. The method of claim 17, wherein the penetrable panel comprises a resiliently-penetrable panel, and wherein the method further comprises, after the step of inserting the narrowed, penetrating tip into the resiliently-penetrable panel:
removing the narrowed, penetrating tip from the resiliently-penetrable panel;
inserting the narrowed, penetrating tip into the resiliently penetrable panel a second time.

19. The method of claim 18, wherein the step of inserting the narrowed, penetrating tip into the resiliently-penetrable panel a second time comprises inserting the narrowed, penetrating tip into the resiliently-penetrable panel at a location distinct from a location at which the narrowed, penetrating tip was previously inserted into the resiliently-penetrable panel.

20. The method of claim 17, further comprising:
removing the penetrable panel from the interior surface of the storage structure; and
coupling a new penetrable panel with the interior surface of the storage structure.

21. The system of claim 1, wherein the panel comprises a plurality of slots configured to receive shelf-supporting structures.

22. The system of claim 1, wherein the panel comprises a resiliently-penetrable panel comprising at least one of a closed-cell polyethylene foam and a closed cell polyurethane foam.

23. The system of claim 1, wherein the panel comprises a resiliently-penetrable panel comprising a ductile foam material configured to allow the narrowed tip to be repeatedly inserted and withdrawn from the panel.
